(19) United States
(12) Patent Application Publication
(10) Pub. No.: US 2022/0263725 A1
(43) Pub. Date: Aug. 18, 2022

(54) Identifying Unused Servers

(71) Applicant: BAYER AKTIENGESELLSCHAFT, Leverkusen (DE)

(72) Inventors: Sven MAYER ZU EISSEN, Witten (DE); Josephine BRAVIDOR, Berlin (DE)

(73) Assignee: BAYER AKTIENGESELLSCHAFT, Leverkusen (DE)

(21) Appl. No.: 17/625,617

(22) PCT Filed: Jul. 2, 2020
(86) PCT No.: PCT/EP2020/068642

§ 371 Date: Jan. 20, 2022

(30) Foreign Application Priority Data
Jul. 9, 2019 (EP) 19185084.1

(51) Int. Cl. H04L 41/147; G06N 20/00; H04L 41/16

(52) U.S. Cl. CPC H04L 41/147; H04L 41/16; G06N 20/00

(57) ABSTRACT

The present invention relates to finding unused servers in a network. The invention also relates to a method, a device and to a computer program product for finding unused servers.

The present invention relates to finding unused servers in a network. The present invention provides a method, a device, and a computer program product for finding unused servers.

In many organizations, the IT infrastructures are complex and insufficiently documented. For instance, often changes are not (sufficiently) documented and/or test servers are forgotten. When IT employees move to a new post, the unwritten knowledge about the IT infrastructure is lost. IT components are consequently forgotten and unused. According to one estimate, on average 30% of the servers in today's computing centers are unused (https://blog.anthesisgroup.com/30-of-servers-are-sitting-comatose).

Identifying and eliminating unused servers not only cuts operating costs and the cost of energy, maintenance, software licenses and premises, but also reduces security risks and lowers the likelihood of network components failing.

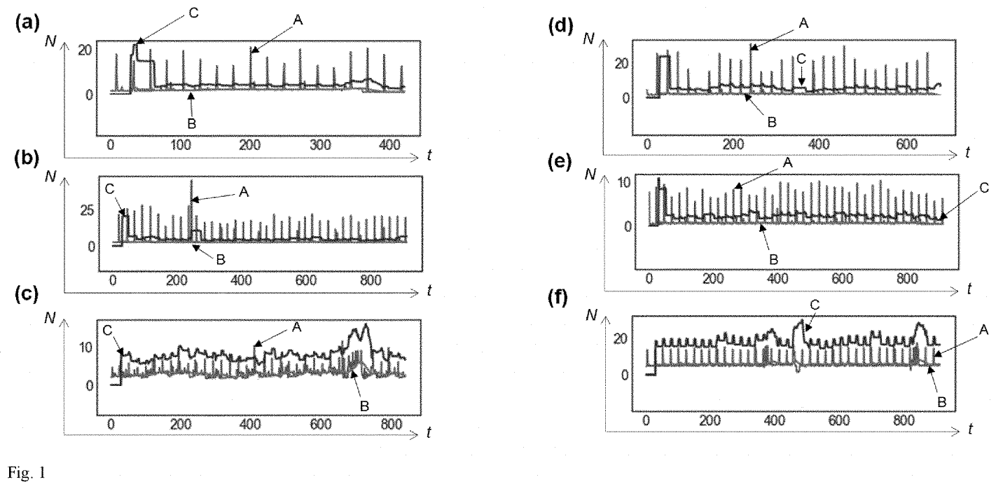

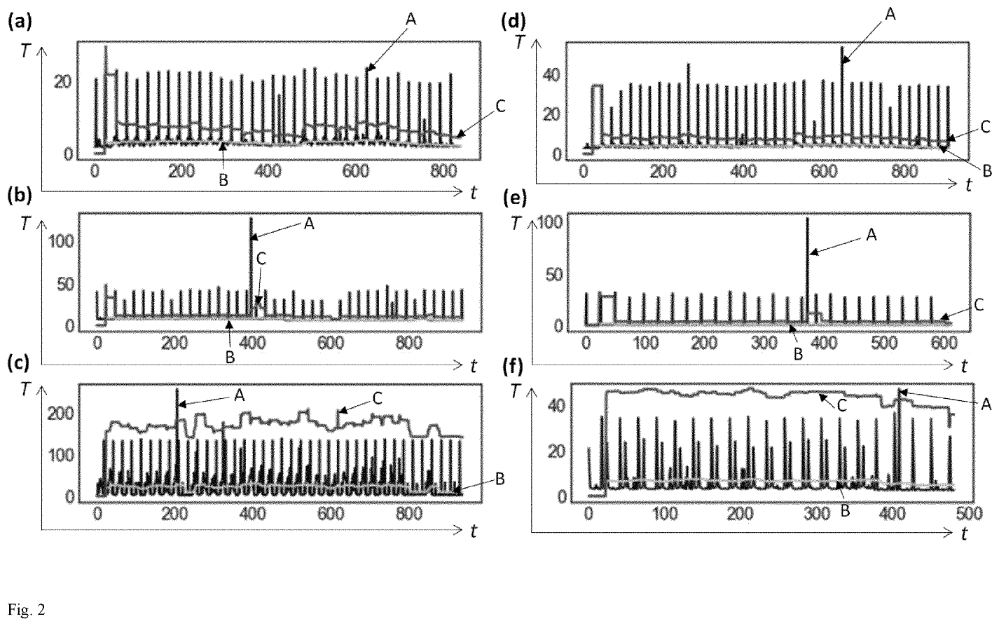

It is not enough to monitor the CPU usage (CPU: central processing unit) or network traffic in order to identify unused servers. Studies carried out in-house in an internal network were able to confirm this (see FIGS. 1 and 2 and the associated explanation later in this document). One reason for this is that there is no intuitive criterion for distinguishing unused servers from used servers, because standard processes such as patching and virus scanning, which generate CPU load and network traffic, are usually running on all servers. In addition, forgotten servers often still have applications installed that start automatic processes and hence create CPU load and network and storage traffic. In fact, CPU, network and storage profiles can look amazingly similar for used and unused servers.

In their publication entitled “Hunt for Unused Servers”, N. Joukov and V. Shorokhov propose a method for identifying unused IT resources on the basis of topological inter-dependencies of the IT components and propagation of usage information along an interdependency graph (https://www.usenix.org/system/files/conference/cooldc16/cooldc16-paper-joukov.pdf).

The proposed method is time-consuming, however, because it looks at the entirety of interconnected servers, and relevant usage information has to be collected for each server, as explained below. The topology analysis proposed in the cited publication is based on analysing network communication. In other words, starting from front-end servers, the method explores which servers these subsequently address. It is often not possible to collect this usage data for Intranet applications by means of hardware, because the servers of an Intranet application are usually located in the same logical network and are not normally separated by a firewall, where such data might be collected. Therefore such an analysis is based on installing local scripts that log the network connections directly on the server. This requires developing appropriate scripts that do not jeopardise ongoing operation, distributing these scripts to all the servers, then gathering the results from all the servers and evaluating the massive deluge of data. As in-house studies have shown, just logging the network connections on a server can cause storage and

CPU problems, posing a risk to the running application. The evaluation is made more difficult in particular by the fact that communication takes place not just with servers from the same application but with many other infrastructure components such as authentication servers, SIEM servers, anti-virus servers, patching servers, monitoring servers, backup servers, administration servers, file servers, etc.

Proceeding from the prior art, the technical object is to identify unused servers in a network in an efficient and effective manner.

This object is achieved by the subjects of the independent claims. Preferred embodiments can be found in the dependent claims and also in the present description and the drawings.

In a first aspect, the present invention provides a method comprising the steps of:
capturing data about the activity of a server;
entering the data into a prediction model, which prediction model has been trained, on the basis of a training dataset relating to the activity of reference servers, to distinguish unused reference servers from used reference servers;
receiving a probability value, which probability value represents a probability that the server is an unused server;
conveying a message to a user, which message comprises information about whether the server is an unused server or a used server.

In a further aspect, the present invention provides a device comprising:
an input unit,
a control and calculation unit, and
an output unit,
   wherein the control and calculation unit is configured to cause the input unit to receive data about the activity of a server,
   wherein the control and calculation unit is configured to calculate a probability value on the basis of the data about the activity of the server, which probability value represents a probability that the server is an unused server, wherein a prediction model calculates the probability value, which prediction model has been trained, on the basis of a training dataset relating to the activity of reference servers, to distinguish unused reference servers from used reference servers,
   wherein the control and calculation unit is configured to cause the output unit to output to a user the probability value and/or information derived from the probability value.

In a further aspect, the present invention provides a computer program product comprising a computer program that can be loaded into a main memory of a computer, where it causes the computer to execute the following steps:
receiving data about the activity of a server;
feeding the data to a prediction model, which prediction model has been trained, on the basis of a training dataset relating to the activity of reference servers, to distinguish unused reference servers from used reference servers;
calculating a probability value using the prediction model, which probability value represents a probability that the server is an unused server;
outputting to a user the probability value and/or information derived from the probability value.

The invention is explained in more detail below without distinguishing between the aspects of the invention (method, device, computer program product). The explanations that follow shall instead apply analogously to all aspects of the invention, regardless of the context (method, device, computer program product) in which they are given.

If steps are stated in an order in the present description or in the claims, this does not necessarily mean that the invention is restricted to the stated order. On the contrary, it is possible for the steps also to be able to be executed in a different sequence or else in parallel to one another, unless one step builds upon another step, which by definition means that the step building upon the other is executed subsequently (but this will be clear in the individual case). The orders stated are thus preferred embodiments of the invention.

The present invention makes it possible to ascertain for a server, on the basis of activity data, quickly, easily and with a low error rate, whether the server is a used or unused server.

A “server” is a computer that provides computer functionalities such as service programs, data or other resources so that they can be accessed by other computers or programs (“clients”) via a network.

A “computer” is an electronic data processing device that processes data by way of programmable computing rules. The principle generally applied today, also known as the Von Neumann architecture, defines for a computer five main components: the processing unit (largely the arithmetic logic unit (ALU)), the control unit, the bus unit, the memory unit and the input/output device(s). In modern computers, the ALU and the control unit are usually amalgamated into one component called the CPU (central processing unit).

In computer technology, “peripherals” denotes all devices that are connected to the computer and are used to control the computer and/or as input and output devices. Examples thereof are monitor (screen), printer, scanner, mouse, keyboard, drives, camera, microphone, speakers, etc. Internal ports and expansion cards are also regarded as peripherals in computer technology.

Modern computer systems are frequently classified as desktop PCs, portable PCs, laptops, notebooks, netbooks and tablet PCs, and what are called handhelds (e.g. smartphones); all these devices can be used for implementing the invention.

The inputs to the computer are made via input means, such as a keyboard, a mouse, a microphone, and/or the like. Outputs are usually achieved via a screen (monitor), on a printer, via loudspeakers and/or by storage on a data memory.

The server for which it is meant to be ascertained whether it is used or unused may be a “virtual server”, i.e. a virtual machine that is used as a server. In IT, “virtual machine” refers to the software encapsulation of a computer system within an executable computer system. The virtual machine emulates the computer architecture of a computer that actually exists in hardware or of a hypothetical computer.

“Activity data” (=data about the activity of a server) is data that indicates activity of a server and/or correlates with the degree of activity. For example, a server is active when data is entering the server and/or leaving the server, and/or calculations are being performed by one or more processors of the server.

Examples of activity data include, inter alia, processor utilization, number of processes being performed at one point in time, main memory available, network activity, CPU temperature, cooling output and power consumption.

The processor utilization (also called CPU load or CPU utilization) is ascertained for multitasking systems. It defines, usually as a percentage, for what proportion of their operating time, one or more of the main processors of a computer are actually working on productive tasks.

The network activity can be specified, for example, as an amount of data per unit of time that is entering the server and/or leaving the server.

One or more of the following items of activity data are preferably captured: CPU usage (e.g. number of processor cores being used), outgoing network traffic (e.g. measured in kbps), incoming network traffic (e.g. measured in kbps), input/output processes for data storage (also known as storage demand, e.g. measured in kbps), main-memory utilization (RAM utilization, e.g. measured in Bytes).

The activity data can be captured using standard software programs (e.g. CPU-ID or HWMonitor Pro from the CPUID company (https://www.cpuid.com/) or vCenter Operations Manager from VMware, Inc (https://www.vmware.com/de/products/vcenter-server.html)).

The activity data is preferably captured over an observation period. The observation period may be, for instance, one hour or a plurality of hours. The observation period preferably equals at least one day, preferably at least 5 days to 10 days.

The activity data can be captured at regular and/or irregular intervals within the observation period. Preferably it is captured at regular intervals, preferably cyclically (e.g. every 1 to 15 minutes or once an hour or the like).

The activity data can be fed as a time series into the prediction model for identifying unused servers. It is also possible, however, to use statistical or other mathematical methods to derive values from the time series that are then fed into the prediction model as the activity data. Examples of such values are: the arithmetic mean over an observation period, the variance, the standard deviation, the maximum, the minimum, the median, the sum, the longest time period containing values above the mean value, the number of values above/below the mean value, Fourier coefficients, entropy, first occurrence of the maximum, quantile values, skewness, the number of peaks, number of values above a multiple of the standard deviation, robust z-score, autocorrelation, linear trend and/or other/additional values.

Usually a feature vector is generated on the basis of the activity data for a server. Generally, a feature vector combines the (preferably numerically) parameterizable properties (features) of an object in a vectorial manner. Different features characteristic of the object form the different dimensions of said vector. The entirety of possible feature vectors is called the feature space. Feature vectors facilitate, for example, automatic classification, since they greatly reduce the properties to be classified. In the present case, the object is the server for which it is meant to be ascertained whether it is used or unused. Each object is assigned a feature vector, which is fed to the prediction model.

The prediction model is preferably a model which has been trained using machine learning to distinguish between used servers and unused servers on the basis of activity data. The prediction model was preferably trained by supervised learning. In this process, a training dataset and a validation dataset from reference servers are normally used in order to generate and validate a statistical model. It is known for each of the reference servers whether it is used or unused. Reference activity data is available for the reference servers. The model learns from a portion of the reference activity data (training dataset) which features of the reference activity data are characteristic of used servers, and which features of the reference activity data are characteristic of unused servers. The remaining portion of the reference activity data (validation dataset) can be used to check how good are the predictions by the prediction model, i.e. at what error rates a prediction is made, on the basis of the reference activity data, for the reference servers of the validation dataset as to whether it is a used or unused server.

The prediction model may be a classification model, for example. On the basis of activity data, said classification model assigns a server to one of at least two classes. A first class comprises unused servers, a second class comprises used servers.

It is conceivable that there are more than two classes. For example, three classes are conceivable: a first class comprising servers for which the probability that they are unused is very high (e.g. greater than 90%), a second class comprising servers for which the probability that they are unused is very low (e.g. less than 10%), and a third class comprising servers which cannot be assigned to either the first or the second class. For the servers in the third class, there is therefore a degree of uncertainty as to whether they are used or unused servers. Meaningful probabilities can be determined from the learning process that was used to create the particular classification model.

The prediction model may also be a regression model. For example, the regression model can calculate for a server, on the basis of activity data, the probability that the server is unused and/or used.

The prediction model (e.g. a classification model or a regression model) is preferably created on the basis of a self-learning algorithm. Particularly preferably, the prediction model is created by means of supervised learning.

For the creation of classification models, there is a multiplicity of methods, such as, for example, random forest or gradient boosting. For the creation of a regression model, there is likewise a multiplicity of methods, such as, for example, logistic regression. These and further methods for classification and regression are variously described in the prior art (see, for example, Norman Matloff: Statistical Regression and Classification—From Linear Models to Machine Learning, Texts in Statistical Science, CRC Press 2017, ISBN 978-1-4987-1091-6; Pratap Dangeti, Statistics for Machine Learning, Packt Publishing 2017, ISBN 978-1-78829-575-8).

It is also conceivable to use an artificial neural network, which has been trained using a training dataset, for instance by means of a backpropagation method, to distinguish unused servers from used servers. Details on generating an artificial neural network can be gathered from the extensive technical literature (see e.g. Francois Chollet: Deep Learning mit Python and Keras, (Deep Learning with Python and Keras) mitp Verlags GmbH & Co. KG, 2018, ISBN 978-1617294433).

The result of model creation is a prediction model (e.g. a classification model or a regression model) that can also be applied to “unknown” servers. An “unknown” server in this context is a server for which it is not known whether it is a used or unused server. The activity data of an “unknown” server is fed into the prediction model, and the prediction model calculates a probability value. The probability value represents a probability that the server is an unused server. The probability value is typically governed by the model that is used. When using a classification model, the probability value (result value) may specify, for example, the class to which the server has been assigned. When using a regression model, the probability value may specify, for example, the probability that the server is an unused server. The probability value is output as a result from the prediction model, and can be output to a user and/or stored. The user can identify from the probability value whether the “unknown” server is (probably) a used server or (probably) an unused server. It is also conceivable that information derived from the probability value rather than the probability value itself is output to the user. For example, it is conceivable that the probability value specifies the probability that the “unknown” server is an unused server; if the probability value lies above a defined threshold value, information can be output to the user that, for example, is interpreted by the user to mean that an unused server is involved. If the probability value lies below a defined threshold value, information can be output to the user that, for example, is interpreted by the user to mean that a used server is involved. The information may be a word, a sentence, a graphic, a symbol, a table entry and/or the like.

The present invention makes it possible to distinguish unused servers from used servers. Experts use the term “comatose server” synonymously with the term “unused server”. The user of the present invention can determine to a certain extent, as part of generating the prediction model, what is meant by an unused server. The prediction model is trained using reference servers and reference activity data. In the case of supervised learning, it is known for the reference servers whether they are used or unused. The user will make the appropriate assignment of the reference servers to used and unused servers depending on what the user means by a used server and an unused server, The prediction model then learns this assignment, which is applied to “unknown” servers. The assignment (i.e. the definition of what an unused server is) is thus anchored in the prediction model.

The following definitions for the term “unused” are therefore merely preferred embodiments of the present invention. It is conceivable that an unused server in the context of the present invention satisfies one or more of the following definitions.

In one embodiment of the present invention, a server is unused when, over a defined timespan, it performs no activity that is caused by a human user in the defined timespan and/or serves a human user in the timespan.

In one embodiment of the present invention, a server is unused when it can be removed from the network without the removal having a negative impact on a (human) user.

In one embodiment of the present invention, a server is unused when it can be removed from the network without a (human) user noticing the removal.

In one embodiment of the present invention, a server is unused when it can be removed from the network without the processes initiated by users on other servers or clients being adversely affected.

In one embodiment of the present invention, a server is unused when it was installed unintentionally and has not been removed again.

In one embodiment of the present invention, a server is unused when it is used by too few people or on too few days and/or occasions.

In one embodiment of the present invention, a server is unused when it has been over-dimensioned. This means that the server has more CPU or RAM available than it needs for itself and the processes it is running.

In a preferred embodiment, the method according to the invention runs automatically as a background process. “Automatic” or “automated” means that no human intervention at all is required. Thus according to the invention, installed on the device according to the invention is a computer program which continuously gathers activity data from servers in a network, generates a feature vector from the activity data for each server, enters the feature vectors into a prediction model, and receives a probability value from the prediction model. The computer program can be configured to compare the probability value with a threshold value. The computer program can be configured to output to a user a name and/or identifier for each server for which the threshold value exceeds the probability value. The user can thereby be informed continuously and in an automated manner about servers in a network that are unused.

The invention is explained in more detail below with reference to an example and figures without any intention to restrict the invention to the features and combinations of features described/shown in the example or the figures.

FIG. 1 contrasts data about the CPU usage of six servers ((a), (b), (c), (d), (e), (f)) during an observation period. The graphs show the CPU usage of the servers (ordinate: number N of active processor cores) as a function of time t (abscissa: time in hours). The graphs labeled with the letter A show the processor cores active at the particular instant in time. The graphs labeled with the letter B show a mean value of the number of active processor cores over a time period of 24 hours (moving average) The graphs labeled with the letter C show the 5-sigma lines (=five standard deviations) for the last 24 hours. The graphs on the left-hand side (FIG. 1 (a), (b), (c)) show the CPU usage by used servers. The graphs on the right-hand side (FIG. 1 (d), (e), (f)) show the CPU usage by unused servers. Each graph of a used server is contrasted with a graph of an unused server of similar behavior ((a)→(d),) (b)→(e), (e)→(f)). It is accordingly not possible to use the obvious examination of CPU usage as the sole basis for intuitive identification of unused servers.

FIG. 2 contrasts data about the network traffic of six servers ((a), (b), (c), (d), (e), (f)) during an observation period. The graphs show rates of the data entering the respective servers (ordinate: data rate 7) as a function of time t (abscissa: time in hours). The graphs labeled with the letter A show the data rates at the particular instant in time. The graphs labeled with the letter B show a mean value of the data rates over a time period of 24 hours (arithmetic mean) The graphs labeled with the letter C show the 5-sigma lines (=five standard deviations) for the last 24 hours. The graphs on the left-hand side (FIG. 1 (a), (b), (c)) show the data rates of used servers. The graphs on the right-hand side (FIG. 1 (d), (e), (f)) show the data rates of unused servers. Each graph of a used server is contrasted with a graph of an unused server of similar behavior ((a)→(d),) (b)→(e), (e)→(f)). It is accordingly not possible to use the obvious examination of data rates as the sole basis for intuitive identification of unused servers.

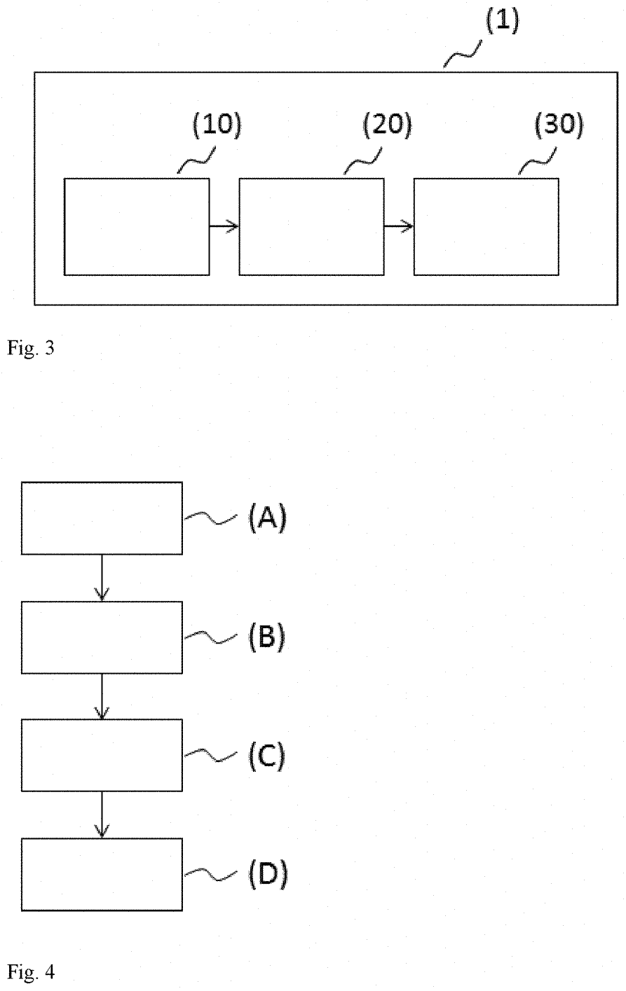

FIG. 3 schematically shows an embodiment of a device according to the invention. The device (1) comprises an input unit (10), a control and calculation unit (20) and an output unit (30). The input unit (10) receives activity data from servers, and forwards this data to the control and calculation unit (20) (represented by the arrow between the input unit and the control and calculation unit). The control and calculation unit (20) comprises a prediction model (not shown explicitly in FIG. 3). The prediction model is trained to distinguish unused servers from used servers on the basis of activity data. The control and calculation unit (20) feeds the activity data to the prediction model. The prediction model calculates a probability value from the activity data. The probability value represents a probability that the server is an unused server. The control and calculation unit (20) transfers the probability value and/or information derived from the probability value to the output unit (30) (represented by the arrow between the control and calculation unit and the output unit). The output unit (30) can indicate to a user the probability value and/or the derived information. The device (1) may be a computer, for example. It is also conceivable to use a plurality of computers interconnected via a network.

FIG. 4 shows schematically an embodiment of the method according to the invention in the form of a flow diagram.

The method comprises the steps of:
(A) capturing data about the activity of a server;
(B) entering the data into a prediction model, which prediction model has been trained, on the basis of a training dataset relating to the activity of reference servers, to distinguish unused reference servers from used reference servers;
(C) receiving a probability value, which probability value represents a probability that the server is an unused server;
(D) conveying a message to a user, which message comprises information about whether the server is an unused server or a used server.

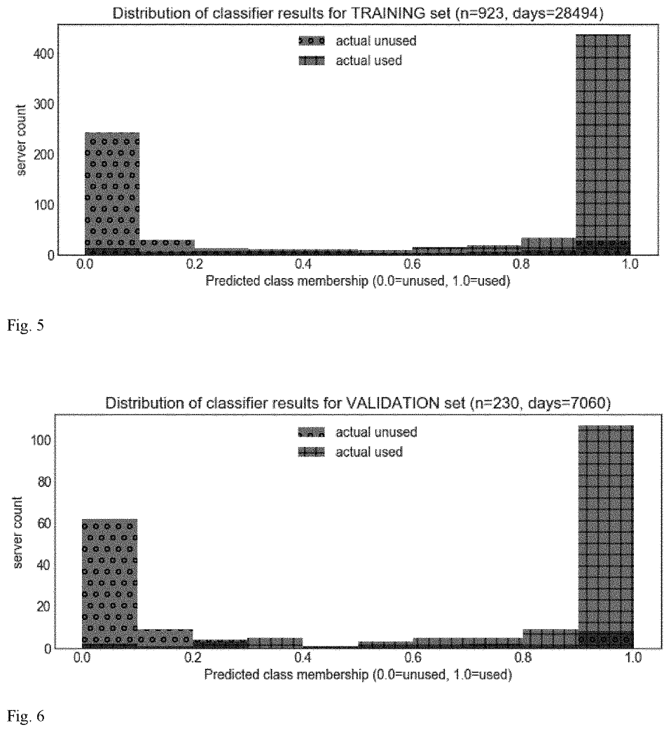

FIGS. 5 and 6 show the results of generating and validating a prediction model using 1153 reference servers in an internal network. It is known for the individual reference servers whether they are used (actual used) or unused (actual unused). A prediction model was trained on the basis of the activity data from 923 servers (training dataset). The processor utilization (in percent), the data entering each server (in kilobits per second), the data leaving each server (in kilobits per second), and input/output processes for data memories (storage demand, in kilobits per second) were examined over an observation period of at least two weeks.

The time-series data was used to train and validate an LSTM (long short-term memory) artificial neural network. In this process, the model was trained to output for unused reference servers a value between 0 and 1, which is approximated as a regression value. A value close to 0 means here that the server associated with the input data is probably unused. Conversely, a regression value close to 1 means that the associated server is probably in use. Then the trained prediction model (LSTM network) was validated by a validation dataset.

FIG. 5 shows the result of the training in the form of a bar diagram. The x-axis (abscissa) is divided into ten segments: 0.0≤x<0.1, 0.1≤x<0.2, 0.2≤x<0.3, 0.3≤x<0.4, 0.4≤x<0.5, 0.5≤x<0.6, 0.6≤x<0.7, 0.7≤x<0.8, 0.8≤x<0.9, 0.9≤x≤1.0. The value x represents the value that the neural network outputs as an output when fed with a feature vector (activity data) for a server. Here x=0.0 means that it is certainly an unused server, and x=1.0 means that it is certainly a used server. Plotted as the ordinate is the number of reference servers for which the prediction model outputs as the output value an x-value within one of the ten segments respectively. The majority of the unused servers are assigned to the segment 0.0≤x<0.1; the majority of the used servers of the class are assigned to the segment 0.9≤x≤1.0.

FIG. 6 shows the result of the validation in the form of a bar diagram. The x-axis (abscissa) is divided into ten segments, as in FIG. 5: 0.0≤x<0.1, 0.1≤x<0.2, 0.2≤x<0.3, 0.3≤x<0.4, 0.4≤x<0.5, 0.5≤x<0.6, 0.6≤x<0.7, 0.7≤x<0.8, 0.8≤x<0.9, 0.9≤x≤1.0 The value x represents the value that the neural network outputs as an output when fed with a feature vector (activity data) for a server. Here x=0.0 means that it is certainly an unused server, and x=1.0 means that it is certainly a used server. Plotted as the ordinate is the number of reference servers for which the prediction model outputs as the output value an x-value within one of the ten segments respectively. The majority of the unused servers are assigned to the segment 0.0≤x<0.1; the majority of the used servers are assigned to the segment 0.9≤x≤1.0.

If a threshold value of 0.3 is input, and if all the servers for which the value x is less than 0.3 are classified as “probably unused”, and all the servers for which the value x is greater than or equal to 0.3 are classified as “probably used” (binary classification), the following confusion matrix can be obtained:

| | prediction: | prediction: |
|---|---|---|
| | “probably used” | “probably unused” |
| actually used | 133 | 8 |
| actually unused | 21 | 68 |

68 of the 89 actually unused reference servers are classed as “probably unused”, and 21 of the 89 actually unused reference servers are classed as “probably used”. 133 of the 141 actually used servers are classed as “probably used”, and 8 of the 141 actually used reference servers are classed as “probably unused”. This gives an accuracy of 87.4%.

The same data (test dataset and validation dataset) was used for training and validating a classification model on the basis of XGBoost. For each of the stated values as a function of time, the following parameters were derived: the global maximum, the arithmetic mean, the longest time period containing values above the mean value (longest strike above mean), the variance, the standard deviation, and Fourier coefficients. This resulted in 24 values for each reference server, from which a feature vector was generated for each reference server. These features were used as the input to the XGBoost method. In this case the accuracy was 92.5%.

By combining the LSTM network and the XGBoost classifier, it was possible to achieve an accuracy of 95.8%. For this purpose, the output values from the two methods (equating the XGBoost classification of “unused” to 0, and “used” to 1; and the LSTM regression value) are combined into a feature vector and given, together with the reference values of the servers to be classified, as input values to a further algorithm. A number of models, including for instance a neural network, are conceivable for this algorithm. In this specific case, once again an XGBoost classifier was calculated. As shown by the result of 95.8% accuracy, it was possible to combine the strengths of the LSTM network and XGBoost successfully in the resultant ensemble.

What is claimed is:

1. A method comprising the steps of:
capturing data about activity of a server;
entering the data into a prediction model, which prediction model has been trained, on the basis of a training dataset relating to the activity of reference servers, to distinguish unused reference servers from used reference servers;
receiving a probability value, which probability value represents a probability that the server is an unused server; and
conveying a message to a user, which message comprises information about whether the server is an unused server or a used server.

2. The method as claimed in claim 1, wherein the data about the activity of the server is selected from the set comprising: number of processor cores used, outgoing network traffic, incoming network traffic, input/output processes for data storage and/or main-memory utilization.

3. The method as claimed in claim 1, wherein the data about the activity of the server is captured over an observation period of at least one day, preferably of at least 5 days, and is fed as a time series into the prediction model.

4. The method as claimed in claim 1, wherein the data about the activity of the server is captured over an observation period of at least one day, preferably of at least 5 days, and statistical or other mathematical methods are used to derive values from the time series that are then fed into the prediction model as the activity data.

5. The method as claimed in claim 4, wherein the activity data is selected from the set comprising: global maximum, arithmetic mean, longest time period containing values above the mean value, variance, standard deviation and/or Fourier coefficients.

6. The method as claimed in claim 3, wherein the data about the activity of the server is captured cyclically over the observation period.

7. The method as claimed in claim 1, wherein the prediction model is a classification model, or comprises a classification model, which assigns the server to one of at least two classes.

8. The method as claimed in claim 1, wherein the prediction model is a regression model, or comprises a regression model, which calculates for the server a probability that the server is used and/or unused.

9. The method as claimed in claim 1, wherein the prediction model has been trained by a supervised learning method to distinguish used servers from unused servers.

10. The method as claimed in claim 1, wherein an unused server is a server that can be removed from the network without the processes initiated by users on other servers or clients being adversely affected.

11. The method as claimed in claim 1, wherein the steps of the method are executed in an automated manner as a background process on a computer.

12. A device comprising:
an input unit;
a control and calculation unit; and
an output unit;
wherein the control and calculation unit is configured to cause the input unit to receive data about the activity of a server;
wherein the control and calculation unit is configured to calculate a probability value on the basis of the data about the activity of the server, which probability value represents a probability that the server is an unused server, wherein a prediction model calculates the probability value, which prediction model has been trained, on the basis of a training dataset relating to the activity of reference servers, to distinguish unused reference servers from used reference servers; and
wherein the control and calculation unit is configured to cause the output unit to output to a user the probability value and/or information derived from the probability value.

13. A device comprising:
an input unit;
a control and calculation unit; and
an output unit;
wherein the control and calculation unit is configured to cause the input unit to receive in an automated manner data about the activity of a multiplicity of servers in a network;
wherein the control and calculation unit is configured to calculate in an automated manner a probability value on the basis of the data about the activity of each server of the multiplicity of servers, which probability value represents a probability that the particular server is an unused server, wherein a prediction model calculates the probability value, which prediction model has been trained, on the basis of a training dataset relating to the activity of reference servers, to distinguish unused reference servers from used reference servers; and
wherein the control and calculation unit is configured to compare in an automated manner, for each server of the multiplicity of servers, the associated probability value with a threshold value, and, if the probability value lies above the threshold value, to cause the output unit to output a message to a user, which message comprises a name and/or an identifier for the servers for which the associated probability value lies above the threshold value.

14. A non-transitory computer program product comprising a computer program which can be loaded into a main memory of a computer, where it causes the computer to execute automatically the following steps:
receiving data about the activity of a server;
feeding the data to a prediction model, which prediction model has been trained, on the basis of a training dataset relating to the activity of reference servers, to distinguish unused reference servers from used reference servers;
calculating a probability value using the prediction model, which probability value represents a probability that the server is an unused server; and
outputting to a user the probability value and/or information derived from the probability value.

15. The non-transitory computer program product as claimed in claim 14, which can be loaded into the main memory of the computer, where it causes the computer to execute automatically in a background process said steps.
